(19) United States
(12) Patent Application Publication
(10) Pub. No.: US 2022/0409478 A1
(43) Pub. Date: Dec. 29, 2022

(54) WEIGHTED MASSAGE ROLLER AND METHODS OF MAKING AND USING SAME

(71) Applicant: Sharon Klinger, Auburn, PA (US)

(72) Inventor: Sharon Klinger, Auburn, PA (US)

(21) Appl. No.: 17/892,596

(22) Filed: Aug. 22, 2022

Related U.S. Application Data
(63) Continuation-in-part of application No. 29/611,535, filed on Jul. 21, 2017, now Pat. No. D961791.

(51) Int. Cl. A61H 15/00

(52) U.S. Cl. CPC A61H 15/0092; A61H 2015/0021; A61H 2201/01

(57) ABSTRACT

A weighted massage roller including a plurality of end rounds, wherein each of the plurality of end rounds has an end round diameter, a plurality of middle rounds, wherein at least one of the plurality of middle rounds is located adjacent to each of the plurality of end rounds, and wherein each of the plurality of middle rounds has a middle round diameter, and a center round located adjacent to another of the plurality of middle rounds, wherein the center round has a center round diameter, and wherein the center round diameter is larger than the middle round diameter of each of the plurality of middle rounds and the end round diameter of each of the end rounds is larger than the center round diameter.

### CROSS-REFERENCE TO RELATED APPLICATIONS

This application is a continuation-in-part of U.S. patent application Ser. No. 29/611,535, filed on Jul. 21, 2017, the disclosure of which is hereby incorporated by reference in its entirety to provide continuity of disclosures to the extent such disclosures are not inconsistent with the disclosure herein.

### FIELD OF THE INVENTION

The present invention is generally related to massage rollers. In particular, this invention is directed to a massage roller which acts upon the user's muscles of the body by holding the weighted massage roller static, moving the weighted massage roller in different directions or placing the weighted massage roller on a flat solid stable surface, placing the user's body (muscles) on the weighted massage roller and holding the weighted massage roller static or rocking the body over the weighted massage roller.

Furthermore, the invention herein is directed to a massage device that allows the user to independently loosen tight muscles on the body, specifically and most beneficially, the muscles of the shoulder (specifically the upper trapezius), forearms, and thighs (specifically the quadriceps). However, the weighted massage roller can be utilized on most other muscles. Furthermore, the user can use the weighted massage roller with zero to minimal force. The weighted massage roller includes a center of the body of the weighted massage roller which, preferably, is the heaviest so that the center of the weighted massage roller can be used to roll over the muscles of the user with zero to minimal force or effort. Furthermore, the concave sections of the weighted massage roller allow the user to give less pressure, if desired. Also, the concave sections also allow the user to massage both thighs (when using multiple weighted massage rollers) at once thereby giving less pressure, if desired. Finally, the ends of the weighted massage roller are the largest in diameter in order to allow the weighted massage roller to be used as a trigger point device or to pinpoint areas that need to be loosened.

### BACKGROUND OF THE INVENTION

Prior to the present invention, as set forth in general terms above and more specifically below, it is known that devices commonly used in self massaging of the quadriceps tend to be massage sticks that require the user's hands to roll, and apply force; foam rollers wherein the foam roller are placed on the floor such that the user's body is placed on top of the roller in the prone position in order to use the user's body weight to perform the massage action, and massage balls that utilize a ball that is placed on the quadriceps while sitting and using force to roll the ball around. Devices commonly used in self massage for forearms include massage balls, as stated above. Devices commonly used to self-massage the upper trapezius include S-shaped devices that utilize the user's force and a knobbed end on the S-shaped device that is placed on the muscle.

It is a purpose of this invention to fulfill these and other needs in the massage roller art in a manner more apparent to the skilled artisan once given the following disclosure.

### BRIEF SUMMARY OF THE INVENTION

This invention is directed to a weighted massage device that allows the user to independently loosen tight muscles of the body, specifically and most beneficially, the muscles of the shoulder (specifically the upper trapezius), forearms, and thighs (specifically the quadriceps). However, the weighted massage roller can be utilized on most other muscles. Furthermore, the user can use the weighted massage roller with zero to minimal force.

The weighted massage roller includes a center of the body of the weighted massage roller which, preferably, is the heaviest so that the center of the weighted massage roller can be used to roll over the muscles of the user with zero to minimal force or effort. Furthermore, the concave sections of the weighted massage roller allow the user to give less pressure, if desired. Also, the concave sections also allow the user to massage both thighs at once (using multiple weighted massage rollers) thereby giving less pressure, if desired. Finally, the ends of the weighted massage roller are the largest in diameter in order to allow the weighted massage roller to be used as a trigger point device or to pinpoint areas that need to be loosened.

A first aspect of the present invention is a weighted massage roller, wherein the roller including a plurality of end rounds, wherein each of the plurality of end rounds has an end round diameter, a plurality of middle rounds, wherein at least one of the plurality of middle rounds is located adjacent to each of the plurality of end rounds, and wherein each of the plurality of middle rounds has a middle round diameter, and a center round located adjacent to another of the plurality of middle rounds, wherein the center round has a center round diameter, wherein the center round diameter is larger than the middle round diameter of each of the plurality of middle rounds and the end round diameter of each of the end rounds is larger than the center round diameter.

In one embodiment of the first aspect of the present invention, the weighted massage roller further includes stainless steel.

In another embodiment of the first aspect of the present invention, the plurality of end rounds further includes a flat surface located on one side of each of the plurality of end rounds.

In another embodiment of the first aspect of the present invention, the weighted massage roller further includes a smooth surface located on each of the plurality of end rounds, each of the plurality of middle rounds, and the center round.

A second aspect of the present invention is a method of making a weighted massage roller, including the steps of: providing a plurality of end rounds, wherein each of the plurality of end rounds has an end round diameter; providing a plurality of middle rounds, wherein at least one of the plurality of middle rounds is located adjacent to each of the plurality of end rounds, and wherein each of the plurality of middle rounds has a middle round diameter; and locating a center round adjacent to another of the plurality of middle rounds, wherein the center round has a center round diameter, wherein the center round diameter is larger than the middle round diameter of each of the plurality of middle rounds and the end round diameter of each of the end rounds is larger than the center round diameter.

In one embodiment of the second aspect of the present invention, the weighted massage roller further includes stainless steel.

In another embodiment of the second aspect of the present invention, the providing a plurality of end rounds further includes providing a flat surface located on one side of each of the plurality of end rounds.

In another embodiment of the second aspect of the present invention, the method further includes providing a smooth surface located on each of the plurality of end rounds, each of the plurality of middle rounds, and the center round.

A second aspect of the present invention is a method of using a weighted massage roller, including the steps of: providing a plurality of end rounds, wherein each of the plurality of end rounds has an end round diameter; providing a plurality of middle rounds, wherein at least one of the plurality of middle rounds is located adjacent to each of the plurality of end rounds, and wherein each of the plurality of middle rounds has a middle round diameter; locating a center round adjacent to another of the plurality of middle rounds, wherein the center round has a center round diameter, wherein the center round diameter is larger than the middle round diameter of each of the plurality of middle rounds and the end round diameter of each of the end rounds is larger than the center round diameter; placing the weighted massage roller on an area of a user that is to be massaged, wherein each of the plurality of end rounds, each of the plurality of middle rounds and the center round contacts the area to be massaged and the plurality of middle rounds create a concave area that provides a lesser pressure on the area to be massaged; and moving the weighted massage roller back and forth over the area to be massaged.

In one embodiment of the third aspect of the present invention, the method further includes providing a flat surface located on one side of each of the plurality of end rounds, wherein the flat surface can be used to stand the weighted massage roller, and wherein the flat surface can be used to apply a pressure to trigger points on the area to be massaged.

In another embodiment of the third aspect of the present invention, the method further includes providing a smooth surface located on each of the plurality of end rounds, each of the plurality of middle rounds, and the center round in order to allow the weighted massage roller can be placed directly on the skin of the user and allows the weighted massage roller to be heated or cooled in order to provide a desired therapeutic effect during the usage of the weighted massage roller.

The preferred weighted massage roller, according to various embodiments of the present invention, offers the following advantages: ease of use; heaviness in weight; durability; the ability to allow the user to independently loosen tight muscles of the body; the ability to use the massage roller with zero to minimal force; and the ability to use the massage roller as a trigger point device or to pinpoint areas that need to be loosened. In fact, in many of the preferred embodiments, these advantages are optimized to an extent that is considerably higher than heretofore achieved in prior, known massage rollers.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is an exploded view of a weighted massage roller taken from circle A in FIG. 4, constructed according to the present invention;

FIG. 2 is an end view of the weighted massage roller, constructed according to the present invention;

FIG. 3 is an isometric view of the weighted massage roller, constructed according to the present invention; and

FIG. 4 is a side view of the weighted massage roller, constructed according to the present invention.

### DETAILED DESCRIPTION OF THE PREFERRED EMBODIMENTS OF THE INVENTION

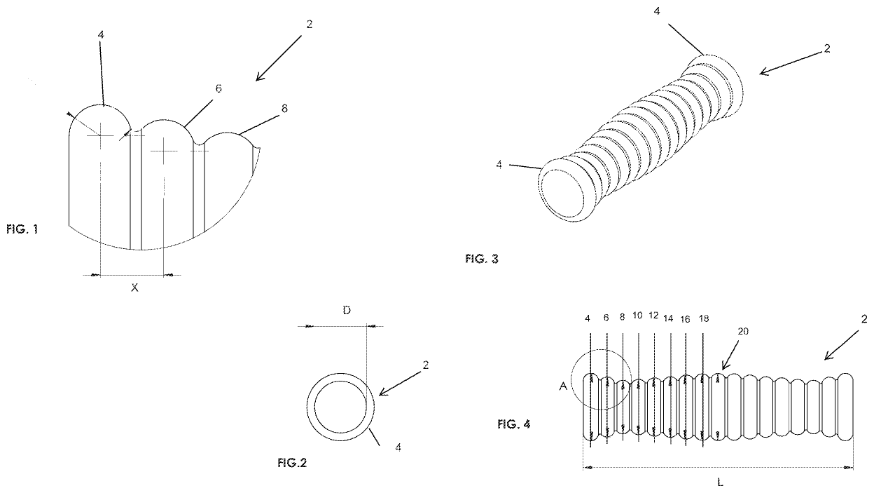

In order to address the shortcomings of the prior, known massage rollers, reference is made now to FIGS. 1-4, where there is illustrated weighted massage roller 2. As will be explained hereinafter in greater detail, the weighted massage roller 2 allows the user to independently loosen tight muscles on a user's body, specifically and most beneficially, the muscles of the shoulder (specifically the upper trapezius), forearms, and thighs (specifically the quadriceps). However, the weighted massage roller 2 can be utilized on most other muscles. Furthermore, the user can use the weighted massage roller 2 with zero to minimal force.

As shown in FIG. 1-4, the weighted massage roller 2 includes, in part, end rounds 4, middle rounds 6-18, and center rounds 20. Preferably, weighted massage roller 2 can be constructed of any suitable, durable, high strength, stain resistant material such as stainless steel or other similar material. Also, end rounds 4, middle rounds 6-18, and center rounds 20 can be constructed on weighted massage roller by conventional techniques such as grinding, milling, forming or the like.

In particular, as shown in FIGS. 1-4, the weighted massage roller 2 includes, in part, approximately 17 rounds (4-20) each having varying diameters to give the user specific pressure on designated areas of the human body. Also, the diameters of the rounds (4-20) can be varied depending upon the size of the weighted massage roller. In particular, a heavier weighted massage roller 2 (i.e., a 10 pound roller) will have overall larger diameter rounds (4-20) when compared to the rounds (4-20) of a lighter weighted massage roller 2 (i.e., a 5 pound roller). Preferably, the diameter (D) range of the rounds 4-20 is as follows:
End round 4—1.98-2.40 cm
Round 6—1.76-2.08 cm
Round 8—1.57-1.81 cm
Round 10—1.63-1.89 cm
Round 12—1.72-2.02 cm
Round 14—1.78-2.11 cm
Round 16—1.88-2.26 cm
Round 18—1.95-2.36 cm
Round 20—1.97-2.39 cm

As shown in FIGS. 1-4, the largest rounds are the end rounds 4 and the center round 20. Preferably, the diameter of the rounds lessens from the end round 4 for two rounds (rounds 6 and 8) with round 8 being the smallest in diameter. The diameter of the rounds then increases until the center round 20. The diameter of the rounds then lessens to the other half of the weighted massage roller 2, then decreases in diameter and, finally, increases to the other end round 4. As can be seen in FIGS. 1-4, the opposing sides on each side of center round 20 of weighted massage roller 2 are equivalent.

As shown in FIG. 2, the rounds, preferably, are located a distance (X) between each other in order to allow each of the rounds (4-20) to provide the desired massage effect when the weighted massage roller 2 is being used. Preferably, the distance (X) can range from 0.47 to 0.67 cm depending upon the size and diameter of the rounds (4-20). Also, the length (L) of the weighted massage roller 2 can range from 7.94 to 11.43 cm depending upon the size and weight of the weighted massage roller 2.

A unique aspect of the weighted massage roller 2 is that it is constructed of a solid heavy metal thereby giving the weighted massage roller 2 the necessary weight which will allow the user to not use force when rolling the weighted massage roller 2 back and forth over the area to be massaged, however additional force can be utilized. When used independently, the user may also place the weighted massage roller 2 on a hard flat surface and then place the body and muscles on top of the weighted massage roller 2 in order to utilize the user's body weight as force to get the desired effect. This can either occur by rolling the body of the user on top of the weighted massage roller 2 or the weighted massage roller 2 can be used without movement for deep pressure and for trigger points. In this manner, the weighted massage roller 2 can be placed on the muscle for deep pressure and trigger points or rolled to massage a larger area at once.

A still another unique aspect of the present invention is that the surface of the weighted massage roller 2 is smooth in order to allow the user to roll the weighted massage roller 2 directly on the skin of the user. In particular, the material that is used in the construction of the weighted massage roller 2 is, preferably, a smooth, dense metal (i.e., stainless steel) which allows the user to get a heavier weight in a smaller massage roller.

Another unique aspect of the present invention is that the weighted massage roller 2 may be optionally equipped with a heating element or a vibrating mechanism (not shown) in order to provide even further massage benefits.

Another unique aspect of the present invention, as shown in FIG. 1-4, is that the center of the body (rounds 16, 18 and 20) of the weighted massage roller 2 is the heaviest which allows the center of the weighted massage roller 2 to roll over the muscles of the user (not shown) while providing zero to minimal force or effort.

A still another unique aspect of the present invention is that the concave sections (rounds 6, 8, 10, 12, and 14) of the weighted massage roller 2 allow the user to give less pressure, if desired. The concave sections also allow the user to massage both thighs of the user at once (when using multiple weighted massage rollers 2) while giving less pressure, if desired.

An even further unique aspect of the present invention is the end rounds of the weighted massage roller 2 which are the largest in diameter(D) in order to allow the weighted massage roller 2 to be used as a trigger point device or to pinpoint areas that need to be loosened.

Another unique aspect of the present invention is that one side of the end rounds 4 is flat so that the weighted massage roller 2 can stand on end rounds 4.

A still another unique aspect of the present invention is that the weighted massage roller 2 can be conventionally heated or cooled in order to provide a desired therapeutic effect during the usage of the weighted massage roller 2.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description hereinabove is not intended to limit the invention, except as indicated in the appended claims.

Therefore, provided herein are a new and improved weighted massage roller. The preferred weighted massage roller, according to various embodiments of the present invention, offers the following advantages: ease of use; heaviness in weight; durability; the ability to allow the user to independently loosen tight muscles of the body; the ability to use the massage roller with zero to minimal force; and the ability to use the massage roller as a trigger point device or to pinpoint areas that need to be loosened.

In fact, in many of the preferred embodiments, these advantages of ease of use, heaviness in weight, durability, the ability to allow the user to independently loosen tight muscles of the body, the ability to use the massage roller with zero to minimal force, and the ability to use the massage roller as a trigger point device or to pinpoint areas that need to be loosened are optimized to an extent that is considerably higher than heretofore achieved in prior, known massage rollers.

What is claimed is:

1. A weighted massage roller, wherein the roller comprises:
a plurality of end rounds, wherein each of the plurality of end rounds has an end round diameter;
a plurality of middle rounds, wherein at least one of the plurality of middle rounds is located adjacent to each of the plurality of end rounds, and wherein each of the plurality of middle rounds has a middle round diameter; and
a center round located adjacent to another of the plurality of middle rounds, wherein the center round has a center round diameter,
wherein the center round diameter is larger than the middle round diameter of each of the plurality of middle rounds and the end round diameter of each of the end rounds is larger than the center round diameter.

2. The weighted massage roller, according to claim 1, wherein the weighted massage roller is further comprised of:
stainless steel.

3. The weighted massage roller, according to claim 1, wherein the plurality of end rounds is further comprised of:
a flat surface located on one side of each of the plurality of end rounds.

4. The weighted massage roller, according to claim 1, wherein the weighted massage roller further comprises:
a smooth surface located on each of the plurality of end rounds, each of the plurality of middle rounds, and the center round.

5. A method of making a weighted massage roller, comprising the steps of:
providing a plurality of end rounds, wherein each of the plurality of end rounds has an end round diameter;
providing a plurality of middle rounds, wherein at least one of the plurality of middle rounds is located adjacent to each of the plurality of end rounds, and wherein each of the plurality of middle rounds has a middle round diameter; and
locating a center round adjacent to another of the plurality of middle rounds, wherein the center round has a center round diameter,
wherein the center round diameter is larger than the middle round diameter of each of the plurality of middle rounds and the end round diameter of each of the end rounds is larger than the center round diameter.

6. The method, according to claim 5, wherein the weighted massage roller is further comprised of:
stainless steel.

7. The method, according to claim 5, wherein the providing a plurality of end rounds is further comprised of:
providing a flat surface located on one side of each of the plurality of end rounds.

8. The method, according to claim 1, wherein the method further comprises:
providing a smooth surface located on each of the plurality of end rounds, each of the plurality of middle rounds, and the center round.

9. A method of using a weighted massage roller, comprising the steps of:
providing a plurality of end rounds, wherein each of the plurality of end rounds has an end round diameter;
providing a plurality of middle rounds, wherein at least one of the plurality of middle rounds is located adjacent to each of the plurality of end rounds, and wherein each of the plurality of middle rounds has a middle round diameter;
locating a center round adjacent to another of the plurality of middle rounds, wherein the center round has a center round diameter,
wherein the center round diameter is larger than the middle round diameter of each of the plurality of middle rounds and the end round diameter of each of the end rounds is larger than the center round diameter;
placing the weighted massage roller on an area of a user that is to be massaged, wherein each of the plurality of end rounds, each of the plurality of middle rounds and the center round contacts the area to be massaged and the plurality of middle rounds create a concave area that provides a lesser pressure on the area to be massaged; and
moving the weighted massage roller back and forth over the area to be massaged.

10. The method, according to claim 9, wherein the method further comprises:
providing a flat surface located on one side of each of the plurality of end rounds, wherein the flat surface can be used to stand the weighted massage roller, and
wherein the flat surface can be used to apply a pressure to trigger points on the area to be massaged.

11. The method, according to claim 9, wherein the method further comprises:
providing a smooth surface located on each of the plurality of end rounds, each of the plurality of middle rounds, and the center round in order to allow the weighted massage roller can be placed directly on the skin of the user and allows the weighted massage roller to be heated or cooled in order to provide a desired therapeutic effect during the usage of the weighted massage roller.
